(19) United States
(12) Patent Application Publication
(10) Pub. No.: US 2021/0215266 A1
(43) Pub. Date: Jul. 15, 2021

(54) VALVE

(71) Applicant: Vitesco Technologies GmbH, Hannover (DE)

(72) Inventor: Rosario BONANNO, Schwalbach a. Ts. (DE)

(21) Appl. No.: 16/771,967

(22) PCT Filed: Dec. 13, 2018
(86) PCT No.: PCT/EP2018/084714

§ 371 Date: Jun. 11, 2020

(30) Foreign Application Priority Data
Dec. 18, 2017 (DE) 10 2017 223 022.3

(51) Int. Cl. F16K 31/06; F16K 1/34

(52) U.S. Cl. CPC F16K 31/0655; F16K 39/022; F16K 31/0651; F16K 1/34

(57) ABSTRACT

A valve having a housing, a solenoid arranged in the housing, a pin movable by the solenoid, a cup-shaped piston connected to the pin, a seal arranged in the base region of the piston that interacts with a valve seat, and a seal arranged in the region of the open end of the piston and seals the piston from the housing. The seal interacting with the valve seat has an outer diameter, which approximately corresponds to the outer diameter of the seal at the open end of the piston.

### CROSS REFERENCE TO RELATED APPLICATIONS

This is a U.S. national stage of Application No. PCT/EP2018/084714 filed Dec. 13, 2018. Priority is claimed on German Application No. DE 10 2017 223 022.3 filed Dec. 18, 2017 the content of which is incorporated herein by reference.

### BACKGROUND OF THE INVENTION

### 1. Field of the Invention

The invention relates to a valve comprising a housing, a solenoid arranged in the housing, a pin moved by the solenoid, a cup-shaped piston connected to the pin, a seal arranged in the base region of the piston that interacts with a valve seat, and a seal or stop in the region of the open end of the piston.

### 2. Description of Related Art

Such valves are used, inter alia, as a recirculation dump valve on the turbocharger in motor vehicles to open up a bypass to the suction side in overrun operation, and are thus known. To prevent excessive deceleration of the turbocharger, but also to ensure a fast start-up, rapid opening and closing of the valve are essential prerequisites. In particular during the closing process, immediate closure as a result of the abutment of the piston against a valve seat is of importance. The valve seat is formed by the housing of the turbocharger, on which the valve is flange-mounted. In addition, the axially displaceable piston must be sealed against the housing or its movement must be limited. It is known to provide a seal or stop on the piston, wherein the seal or stop covers the entire outside so that both sealing tasks are performed by one seal. The seal has a relatively large sealing lip at the open end of the piston. The size of the sealing lip is necessary since, during opening and closing of the valve, the piston is moved relative to the valve and the seal must be guaranteed both in the rest state and during the piston movement. The same applies to a stop. This also has a large outer diameter to act as a dimensionally stable stop. The seal in the base region of the piston however has a smaller outer diameter, whereby the projected areas are unequal. Consequently, an additional resulting force acts in the closing direction and holds the piston in the closed position. The disadvantage here is that on opening of the valve, the solenoid must produce a correspondingly large magnetic force in order also to overcome the resulting force. Accordingly, such a valve needs a large solenoid which must be energized with a corresponding current.

### SUMMARY OF THE INVENTION

One aspect of the invention is a valve that requires a lower current consumption for opening and closing.

According to one aspect of the invention, the seal interacting with the valve seat has an outer diameter that corresponds approximately to the outer diameter of the seal or stop at the open end of the piston. This design according to one aspect of the invention achieves that the projected areas of the two seals are approximately equal in size. When the piston is pressurized, a resulting force is created that is approximately nil or differs slightly from nil. A force differing from nil is so low that it is negligible for the design of the solenoid, in particular the coil and the power supply. The advantage is that the coil may thus be dimensioned smaller. The valve according to one aspect of the invention therefore requires less installation space and has a significantly lower weight. The associated lower power requirement reduces the load on the on-board network and leads to lower fuel consumption.

If the two outer diameters of the seals are precisely the same, the resulting force is equal to nil. This however imposes high requirements in production in order to keep the production-related tolerances correspondingly small. Such a high and hence costly production complexity can be avoided if, according to an advantageous embodiment, the dimensions of the two outer diameters differ slightly, preferably by maximum 5% and in particular maximum 3%. The resulting force thus created is negligible with respect to the magnetic force of the solenoid.

Also, a further advantage has been found if the seal in the base region has a smaller outer diameter than the seal at the open end. Since in mounted state, the sealing lip of the seal at the open end of the piston lies on the valve housing, its outer diameter in the installation position is already reduced and now approaches the outer diameter of the seal in the base region of the piston due to installation.

Good resistance to media by the seal is ensured by the use of rubber, preferably a fluoro rubber, as a seal material. Another advantage is that a rubber seal of this kind is temperature-resistant up to 180° C.

A reliable connection of the seal or stop to the piston is advantageously achieved if the rubber is vulcanized on.

The valve can be produced with low weight if the seal interacting with the valve seat and the seal or stop at the open end of the piston are separate components.

According to one aspect of the invention, a reliable connection between seal and piston is achieved if the seal interacting with the valve seat and the seal or stop at the open end of the piston are formed integrally.

According to one aspect of the invention, production of the valve is simplified if the seal interacting with the valve seat and the seal or stop at the open end of the piston are mounted as a cover on the piston. The advantage here is that the cover can be produced separately and then mounted on the piston.

For adequate stability of the seal on the valve seat, it is advantageous if the outer diameter of the seal has an axial height of 10% to 50% of the piston height.

Weight and costs may be saved if the outer diameter of the seal becomes smaller in the direction of the open end of the piston. This reduction in outer diameter may take place in stages or in the form of a chamfer or radius. The latter allows easier production.

With a view to reducing material usage while retaining adequate functionality, it has proved advantageous if the thickness of the seal or stop at the open end of the piston is 0.4 mm to 1 mm, preferably 0.5 mm to 0.8 mm.

A stop here means a stop that cooperates with the housing or a housing part in the closing direction of the valve. The stop may be formed in the manner of a sealing lip towards the radial outside and in the direction of the solenoid. Here, an angle of 45° to 60° has proved advantageous. In this case, the stop acts as a seal.

Furthermore, it is advantageous if the stop also has a cylindrical stop face. This may be used as a stop on movement of the piston into the open position. In this way, with just one component and at little cost, a stop may be created for both movement directions of the piston.

A greater resistance to aggressive media and hence a longer service life are achieved if the piston is made from stainless steel, preferably a chromium-nickel steel. A metal piston also has the advantage of greater temperature resistance so that a valve according to one aspect of the invention may cover a wider field of use, in particular with high temperatures.

Owing to the greater stability of metal in relation to plastic, the wall thickness of the piston can be made significantly smaller. Depending on the field of use, it has proven to be advantageous if the metal of the piston has a thickness of 0.3 mm to 1 mm, preferably of 0.4 mm to 0.8 mm, and in particular of 0.5 mm.

According to one aspect of the invention, the piston can be produced at a particularly low cost in a single work step if the piston is a deep-drawn part.

Depending on the conditions of use however, it is also conceivable to make the piston from a plastic and form the stop and seal as a one-piece cover over the piston.

### BRIEF DESCRIPTION OF THE DRAWINGS

The invention will be described in more detail on the basis of an exemplary embodiment. In the figures:

FIG. 1 is a sectional illustration of a valve according to the prior art;

FIG. 2 is an enlarged sectional illustration of the valve according to the invention in the region of the piston; and

FIG. 3 is an enlarged sectional illustration of a piston.

### DETAILED DESCRIPTION OF THE PRESENTLY PREFERRED EMBODIMENTS

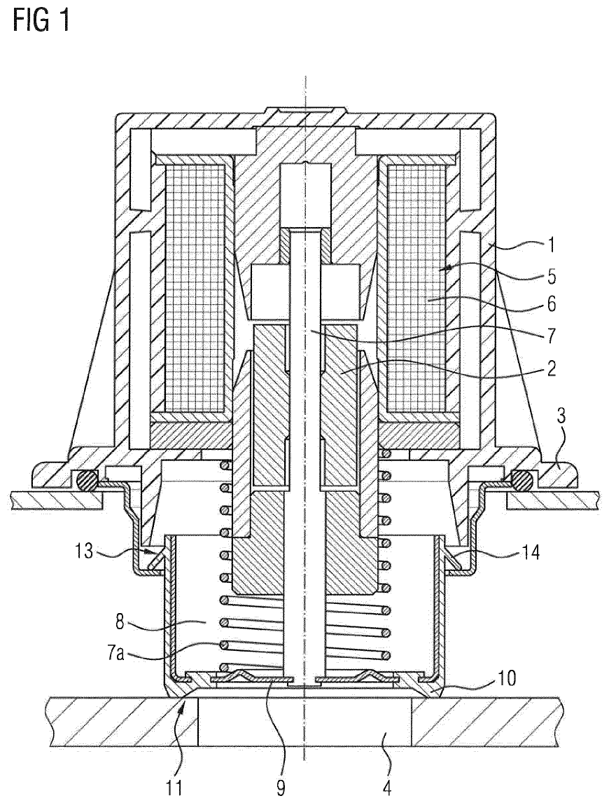

FIG. 1 shows the valve, which comprises a housing 1. The housing 1 has an integrally formed flange 3, via which the housing 1 is flanged-mounted on a turbocharger (not illustrated) in a region of the bypass line 4. In the housing 1, there is a solenoid 5 with a coil 6 and a metal pin 7. The metal pin 7 is connected to a cup-shaped piston 8 that has a seal 10 at the periphery of its base 9. In the closed position shown, the seal 10 bears against the valve seat 11 in order to close off the bypass line 4, so that no medium can flow from the line 4 into the line 12. Here, a spring 7a pushes the piston 8 in the direction of the valve seat 11. A further seal 13 with a sealing lip 14 is arranged at the open end of the piston 8. If the solenoid 5 is electrically energized, a magnetic force acts on the armature 2, whereby the piston 8 is moved in the direction of the housing 1. Here, the sealing lip 14 seals off the piston 8 against the housing 1.

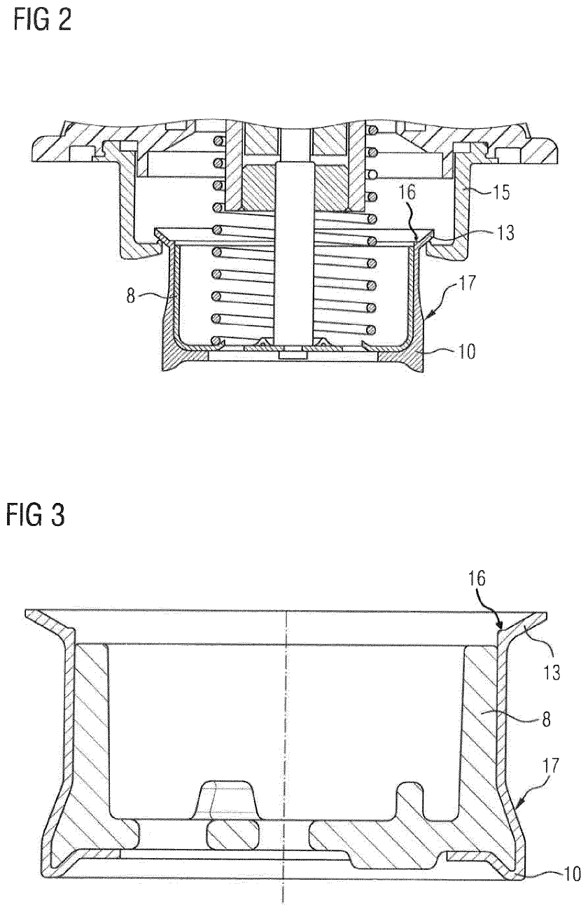

In FIG. 2, the metallic piston 8 also has a stop 13 at the open end of the piston 8, and a seal 10 in the base region of the piston 8. The stop 13 extends at an angle of 45° towards the radial outside and in the direction of the solenoid 5 and has a thickness of 0.8 mm. In the closing direction of the valve, the stop 13 meets a housing part 15 where it seals the piston 8 against the housing 1. On the radial inside, the stop 13 has a cylindrical stop face 16 which, on movement of the piston into the open position, cooperates with a correspondingly formed face of the housing 1 and thus limits the further movement of the piston 8.

The seal 10 and stop 13 are produced integrally from fluoro rubber, wherein this component is mounted on the piston 8 as a cover. The seal 10 has an outer diameter which corresponds approximately to the outer diameter of the stop 13 or is slightly smaller. A resulting force is negligible in relation to the magnetic force produced by the solenoid. The outer diameter of the seal 10 is constant over an axial height of 40% of the piston height. In the further axial course, the outer diameter of the cover reduces in the form of a chamfer 17 to approximately 1 mm. With this thickness, the cover transforms into the stop 13 at the open end of the piston 8.

The piston 8 in FIG. 3 consists of plastic with a covering of elastomer which forms the stop 13 and the seal 10. The piston 8 corresponds in basic structure to the piston of FIG. 2. The difference is that the elastomer covering has an almost constant thickness. The increase in outer diameter in the region of the seal 10 is achieved by a correspondingly greater wall thickness of the plastic piston 8 in this region.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A valve comprising:
a housing;
a valve seat;
a solenoid arranged in the housing;
a pin configured to be moved by the solenoid;
a cup-shaped piston connected to the pin;
a first seal arranged in a base region of the cup-shaped piston that interacts with the valve seat; and
a second seal or a stop in a region of an open end of the cup-shaped piston,
wherein the first seal interacting with the valve seat has an outer diameter that substantially corresponds to an outer diameter of the second seal or stop at the open end of the cup-shaped piston.

12. The valve as claimed in claim 11, wherein the outer diameters of the first seal and the second seal or stop differ by maximum 5%.

13. The valve as claimed in claim 11, wherein the first seal and the second seal or stop are composed of a rubber.

14. The valve as claimed in claim 13, wherein the rubber is vulcanized on.

15. The valve as claimed in claim 11, wherein the first seal interacting with the valve seat and the second seal or stop at the open end of the cup-shaped piston are separate components.

16. The valve as claimed in claim 11, wherein the first seal interacting with the valve seat and the second seal or stop at the open end of the cup-shaped piston are formed integrally.

17. The valve as claimed in claim 13, wherein the first seal interacting with the valve seat and the second seal or stop at the open end of the cup-shaped piston are mounted as a cover on the cup-shaped piston.

18. The valve as claimed in claim 11, wherein the outer diameter of the first seal has an axial height of 10% to 50% of a height of the cup-shaped piston.

19. The valve as claimed in at least one of claim 16, wherein the outer diameter of the first seal becomes smaller in a direction of the open end of the cup-shaped piston.

20. The valve as claimed in claim 11, wherein a thickness of the second seal or stop at the open end of the cup-shaped piston is one of:
0.4 mm to 1 mm and
0.5 mm to 0.8 mm.

21. The valve as claimed in claim 13, wherein the rubber is a fluoro rubber.

22. The valve as claimed in claim 16, wherein the first seal interacting with the valve seat and the second seal or stop at the open end of the cup-shaped piston are mounted as a cover on the cup-shaped piston.
